(19) United States
(12) Patent Application Publication
(10) Pub. No.: US 2011/0145661 A1
(43) Pub. Date: Jun. 16, 2011

(54) Selectively displaying source code defect information within a source code editor

(75) Inventors: Matthew G. Marum, Cary, NC (US); Nirav S. Sheth, Cary, NC (US); Steven K. Speicher, Holly Springs, NC (US); Michael J. Tabb, Raleigh, NC (US)

(73) Assignee: INTERNATIONAL BUSINESS MACHINES CORPORATION, Armonk, NY (US)

(21) Appl. No.: 12/637,099

(22) Filed: Dec. 14, 2009

(51) Int. Cl. G06F 11/36

(52) U.S. Cl. 714/57; 714/E11.217

(57) ABSTRACT

Selectively presenting source code defect information within a source code editor. In the source code editor, a defect tracking identifier can be presented. The defect tracking identifier can be associated with a defect record contained in a defect tracking system. When a user selects the defect tracking identifier, defect information associated with the defect can be automatically retrieved from the defect tracking system. The defect information can be presented in the source code editor.

### BACKGROUND

The embodiments disclosed within this specification relate to editing systems that are used to generate and edit computer-usable program code. More particularly, the embodiments relate to tracking defects in computer-usable program code.

Defect tracking systems oftentimes are used to track defects in computer-usable program code (hereinafter “source code”). For example, when a defect, commonly referred to as a “bug,” is identified in a computer program, administrative personnel oftentimes will create a defect record in the defect tracking system. The defect record generally will include a defect identifier and a brief description of the defect.

Once the defect record has been created, the defect can be queued to receive the attention of computer programmers who are tasked with correcting defects in the computer program code. After the defect has been corrected, the defect tracking system is typically updated with pertinent information related to the fix that was implemented. Accordingly, the details of the defect can be reviewed at a later time by others who may desire to review such information.

### BRIEF SUMMARY OF THE INVENTION

The embodiments disclosed within this specification relate to selectively presenting source code defect information within a source code editor. One embodiment of the present invention can include a method of presenting in the source code editor a defect tracking identifier that is associated with a defect record contained in a defect tracking system. When a user selects the defect tracking identifier, defect information associated with the defect can be automatically retrieved from the defect tracking system. The defect information can be presented in the source code editor.

Another embodiment of the present invention also can include presenting source code defect information within a source code editor. A defect tracking identifier that is associated with a defect record contained in a defect tracking system can be presented in the source code editor. An icon or button proximate to the defect tracking identifier can be presented. The icon or button can be associated with the defect tracking identifier and can be configured to be selected by a user in order to select the defect tracking identifier. When a user selects the defect tracking identifier, defect information associated with the defect can be automatically retrieved from the defect tracking system. The defect information can be presented in the source code editor.

Yet another embodiment of the present invention can include a computer program product including a computer-usable medium having computer-usable program code that, when executed, causes a machine to perform the various steps and/or functions described herein.

### BRIEF DESCRIPTION OF THE SEVERAL VIEWS OF THE DRAWINGS

FIG. 1 is a block diagram illustrating a system for of selectively presenting source code defect information within a source code editor in accordance with an embodiment of the present invention.

FIG. 2 presents a view of source code editor in accordance with an embodiment of the present invention.

FIG. 3 presents another view of a source code editor in accordance with an embodiment of the present invention.

FIG. 4 is a flow chart illustrating a method of selectively presenting source code defect information within a source code editor in accordance with an embodiment of the present invention.

### DETAILED DESCRIPTION OF THE INVENTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

In accordance with the present invention, source code defect information can be selectively presented within a source code editor. In illustration, when a computer programmer edits computer-usable program code (hereinafter “source code”) to correct a defect in the source code, the computer programmer can enter a defect tracking identifier into the source code to indicate the defect that is being addressed. For instance, the defect tracking identifier can be entered in-line with the source code, for example above or below a portion of the source code that is being edited. In this regard, to edit source code means to change, delete and/or add lines of code within the source code.

When a computer programmer is reviewing or editing the source code, and selects the defect tracking identifier, the defect information can be automatically retrieved and presented in the source code editor, for example on a display or in a print of the source code. The defect information can be presented in-line with the source code, for instance in a collapsible section of the source code. In another embodiment, the defect information can be presented in a pop-up dialog, as hover text, or can be presented in any other suitable manner.

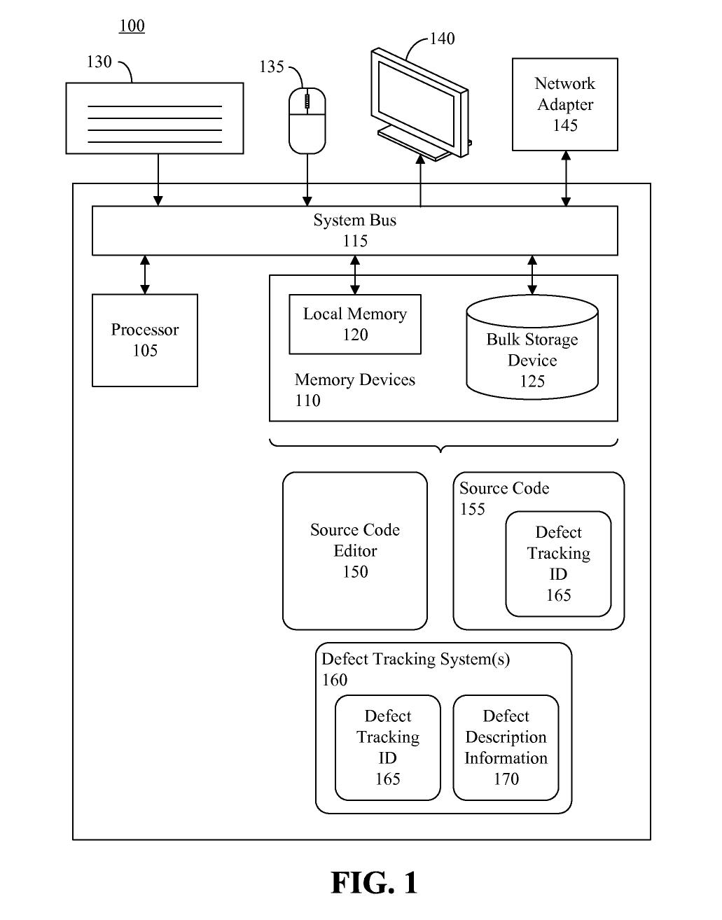

FIG. 1 is a block diagram illustrating a system 100 that may be used to selectively present source code defect information within a source code editor in accordance with an embodiment of the present invention. The system 100 can include at least one processor 105 coupled to memory devices 110 through a system bus 115. As such, the system 100 can store program code within the memory devices 110. The processor 105 can execute the program code accessed from the memory devices 110 via system bus 115. In one aspect, for example, the system 100 can be implemented as computer that is suitable for storing and/or executing program code. It should be appreciated, however, that the system 100 can be implemented in the form of any system comprising a processor and memory that is capable of performing the functions described within this specification.

The memory devices 110 can include one or more physical memory devices such as, for example, local memory 120 and one or more bulk storage devices 125. Local memory 120 refers to random access memory or other non-persistent memory device(s) generally used during actual execution of the program code. The bulk storage device(s) 125 can be implemented as a hard drive or other persistent data storage device. The system 100 also can include one or more cache memories (not shown) that provide temporary storage of at least some program code in order to reduce the number of times program code must be retrieved from the bulk storage device 125 during execution.

Input/output (I/O) devices such as keyboard 130, a pointing device 135, and a display 140 also can be coupled to system 100. The I/O devices can be coupled to the system 100 either directly or through intervening I/O controllers. A network adapter 145 also can be coupled to system 100 to enable system 100 to communicate with other systems, computer systems, remote printers, and/or remote storage devices through intervening private or public networks. Modems, cable modems, and Ethernet cards are examples of different types of network adapters that can be used with system 100.

As pictured in FIG. 1, the memory devices 110 can store a source code editor 150. The source code editor 150, being implemented in the form of executable program code, can be executed by the system 100 for the purposes of editing source code in accordance with the methods described herein. For example, when a defect tracking identifier 165 contained in source code 155 is selected, the source code editor 150 can present defect information 170 in-line with the source code 155 when the source code 155 is presented on the display 140, in a print of the source code 155, or when the source code 155 is presented in any other manner. As noted, the defect information 170 can be presented on the display 140 in a collapsible section of the source code. In another embodiment, the defect information can be presented in a pop-up dialog, as hover text, or can be presented in any other suitable manner. The defect information can include, for example, attributes associated with a defect, defect codes, descriptive text, and/or any other information that may be associated with a defect.

In one embodiment, the memory devices 110 of the system 100 also can store a defect tracking system 160 that tracks defects in source code. The defect tracking system 160 can be accessed to retrieve the defect information 170 that is to be presented in the source code editor 150.

In another embodiment, the defect tracking system 160 can be stored on another system or device that is communicatively linked to the system 100. For example, the defect tracking system 160 can be stored in memory devices of a server (not shown), memory devices of a network adapted storage (not shown), or on any other computer-readable medium on which data can be stored. Any such devices and/or systems can be communicatively linked to the system 100 via the network adapter 145 or in any other suitable manner. For example, such devices and/or systems can be communicatively linked to the system 100 via a communication link such as a Universal Serial Bus, an Advanced Technology Attachment (ATA) link, a serial ATA link, and so on. In illustration, the source code editor 150 can reside on a client device, while the defect tracking system 160 resides on a server. Still, any of a myriad of other configurations can be implemented, as will be appreciated by those skilled in the art, and the present invention is not limited to these examples.

The defect information 170 can include information pertaining to specific defects that were, or are, present in the source code 155. This defect information 170 can be contained in one or more records associated with a particular defect. Each of these records can comprise both the defect tracking identifier 165 and the corresponding defect information 170. Of course, the records can comprise any other desired information and the invention is not limited in this regard.

The defect information 170 that is presented in the source code editor 150 can be retrieved from the defect tracking system 160 in a suitable manner. For example, when the defect tracking identifier 165 contained in source code 155 is selected, a query can be generated and communicated to the defect tracking system 160 to request the defect information 170. The query can include as a parameter the defect tracking identifier 165, or any other information that identifies a record containing the defect information 170. In response, the requested defect information 170 can be communicated from the defect tracking system 160 to the source code editor 150.

In one arrangement, the memory devices 110 can store a plurality of defect tracking systems 160. When a defect tracking identifier 165 contained in the source code 155 is selected, that defect tracking identifier 165 can be processed to determine one or more of the defect tracking systems 160 to which it corresponds. Such processing can be performed in any suitable manner.

In illustration, the defect tracking identifier 165 can be parsed, and portions of the parsed defect tracking identifier 165 can be identified. If at least one of the parsed portions of the defect tracking identifier 165 corresponds to a particular defect tracking system 160, then the query can be sent to that defect tracking system 160 requesting the defect information 170. The selection of which defect tracking system 160 is to provide the defect information can be based on sequential characters contained in the defect tracking identifier 165, a pattern of characters contained in the defect tracking identifier 165, or based on any other characteristics of the defect tracking identifier 165. If no parsed portions of the defect tracking identifier 165 correspond to a particular defect tracking system 160, then queries can be sent to each of the defect tracking systems 160.

In response to receiving the query or queries, at least one of the defect tracking systems 160 can communicate the defect information 170 to the source code editor 150. The source code editor 150 can present the defect information 170 in the source code 155.

The queries that are sent to request the defect information 170 can be generated by the source code editor 150, or generated by another application (not shown) that is communicatively linked to the source code editor 150. For example, the source code editor 150 can include one or more functions or processes that, when the defect tracking identifier 165 is selected, generate suitable queries that may be communicated to one or more defect tracking systems 160. Such functions can be implemented using macros, modules, sub-routines, or in any other suitable manner.

In another embodiment, another application (not shown) can be tasked with generating the queries that request the defect information 170. For instance, an application that is configured to generate queries that request the defect information 170 can be called by the source code editor 150 when a defect tracking identifier 165 in the source code 155 is selected. Alternatively, the application can interface with the source code editor 150 to detect user selection of the defect tracking identifier 165. In such arrangements, the defect information 170 can be communicated to the source code editor 150 via the other application, though this need not be the case.

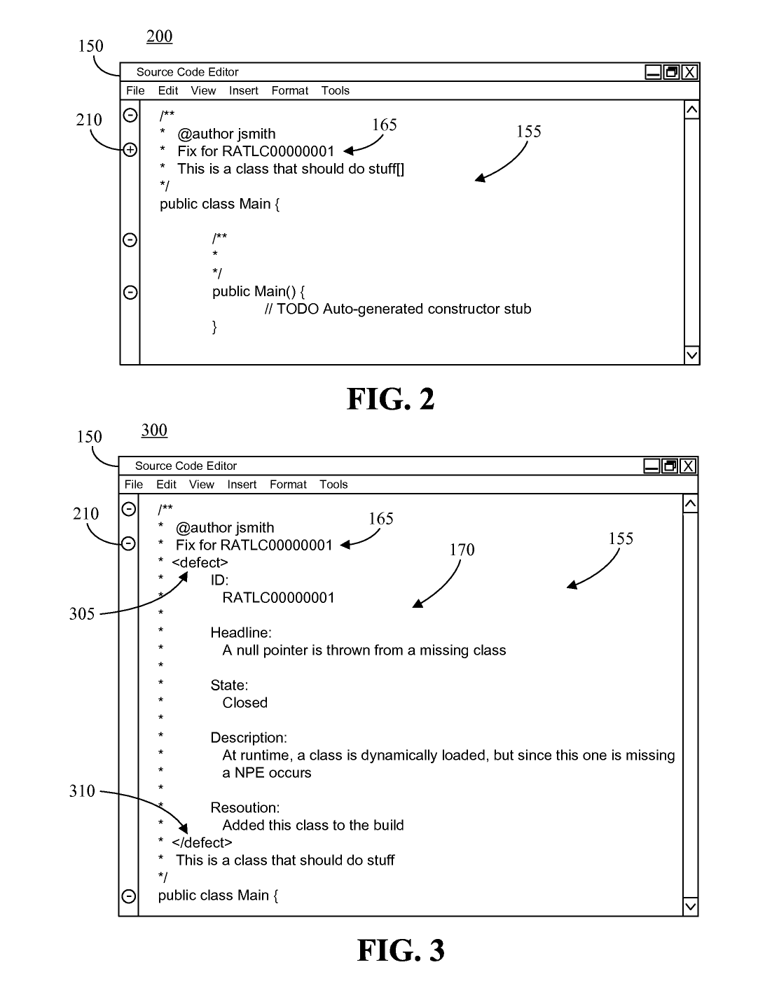

FIG. 2 presents a view 200 of a source code editor 150 in accordance with an embodiment of the present invention. In the source code editor 150, the source code 155 can be presented. In operation, a user, such as a computer programmer, can enter a user input to place the defect tracking identifier 165 into the source code 155. As used herein, a user is a person. The defect tracking identifier 165 can be entered into the source code 155 in any suitable manner. For example, in one embodiment, the user can use a keyboard to enter into the source code 155 alphanumeric characters corresponding to the defect tracking identifier 165. In another embodiment, a list of defect tracking identifiers can be presented to the user, for instance in response to a menu selection, and the user can select from that list the defect tracking identifier 165 that is to be entered into the source code 155. The defect tracking identifier 165 can be placed where a key entry cursor is currently located in the source code 155, can be selectively placed into the source code by the user using a pointing device cursor, or can be placed into the source code 155 in any other suitable manner.

The defect tracking identifier 165 can be selectable by any authorized user who is reviewing and/or editing the source code 155. In one embodiment, to select the defect tracking identifier 165, the user can select alphanumeric characters representing the defect tracking identifier 165. In this regard, the alphanumeric characters representing the defect tracking identifier 165 can be presented in a manner that indicates that the defect tracking identifier 165 is selectable. For example, the alphanumeric characters can be presented in a format that distinguishes the alphanumeric characters as being distinguished from at least one other portion of the source code 155, for instance using capital characters, using a specific font, using a specific font format (e.g., italics, underlining, bold, etc.), presenting the alphanumeric characters with a font in a particular color, presenting the alphanumeric characters with a particular background, or presenting the alphanumeric characters in any other manner suitable for indicating that the alphanumeric characters are selectable.

In another embodiment, a selectable icon (or button) 210 can be presented proximate to the defect tracking identifier 165, or presented in another manner that indicates the selectable icon 210 is associated with the defect tracking identifier 165. This selectable icon 210 can be selected to select the defect tracking identifier 165. The selectable icon 210 also can be presented in a manner which indicates whether the defect tracking identifier 165 has been selected. Moreover, the selectable icon 210 can be configured to toggle between a plurality of indicators that indicate whether the defect tracking identifier 165 has been selected, for instance using “+” and “−” symbols.

Assuming that the defect tracking identifier 165 has not yet been selected, when the defect tracking identifier 165 is selected, one or more suitable queries can be generated to retrieve corresponding defect information from one or more defect tracking systems, for instance as previously described.

Referring to FIG. 3, in response to the query or queries, the defect information 170 can be received from at least one of the defect tracking systems and presented in the source code editor 150. For example, the defect information 170 can be presented in-line with the source code 155. As used herein, to present information “in-line” means to present the information in the same window as the source code 155, for example by expanding the source code 155 in the vertical direction so as to allow the defect information 170 to be inserted into the view of the source code 155 above or below the defect tracking identifier 165. In illustration, the source code 155 can be presented in a collapsible portion of the source code 155 that is expanded to receive and present the defect information 170. Of course, the defect information 170 can be presented in any other suitable manner and the invention is not limited in this regard.

In an embodiment in which the selectable icon 210 is configured to toggle between a plurality of indicators, the selectable icon 210 can be updated in a manner that indicates that the defect tracking identifier 165 has been selected. For example, the selectable icon 210 can be toggled to change a “+” indicator to a “−” indicator.

In one embodiment, tags 305, 310 can be presented to identify the defect information 170. For example, the tag 305 can be presented at a beginning of the defect information 170, and the tag 310 can be presented at an end of the defect information 170. In another embodiment, the defect information 170 can be presented in a format that distinguishes the defect information 170 from other portions of the source code 155, for instance using capital characters, using a specific font, using a specific font format (e.g., italics, underlining, bold, etc.), presenting the font in a particular color, presenting the font with a particular background, or presenting the defect information 170 in any other suitable manner which distinguishes the defect information 170 from the other portions of the source code 155.

When the user no longer desires to be presented the defect information 170, the user can again select the defect tracking identifier 165. As noted, such selection can be performed by selecting the alphanumeric characters representing defect tracking identifier 165 or by selecting an associated icon 210. When the defect tracking identifier 165 is again selected, presentation of the defect information 170 can be discontinued. For example, a portion of the source code 155 in which the defect information 170 is presented can be collapsed. In an arrangement in which the selectable icon 210 is used to control whether the defect information 170 is presented, when the defect tracking identifier 165 is selected to cease presentation of the defect information 170, the selectable icon 210 can be toggled to indicate such. For example, an indicator associated with the icon 210 can be toggled from a “−” indicator to a “+” indicator

The defect information 170 can be retained on the system 100, for example on the memory devices, so that it may again be presented without the need to generate another query to retrieve the defect information 170. For example, the defect information 170 can be retained in cache memory. In some instances, the defect information 170 may be updated, even after being presented in the source code editor 150. Accordingly, a button, icon, or toolbar selection can be presented in the source code editor 150 so as to allow the defect information 170 to be updated. For example, a refresh button can be provided in the source code editor 150. The defect information 170 can be updated, regardless of whether it is presently displayed in the source code editor 150.

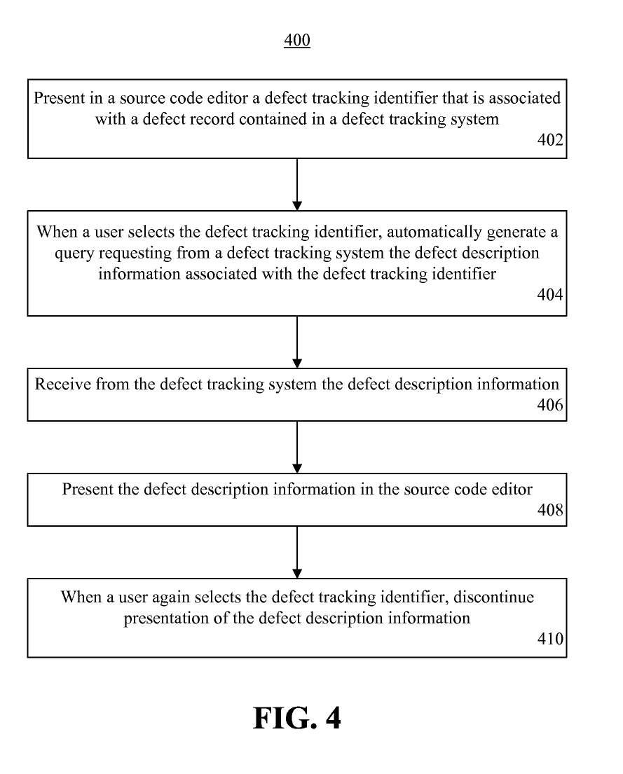

FIG. 4 is a flow chart illustrating a method 400 of selectively presenting source code defect information within a source code editor in accordance with another embodiment of the present invention. At step 402, in a source code editor, a defect tracking identifier can be presented. The defect tracking identifier can be associated with defect information contained in a corresponding record in the defect tracking system.

At step 404, when a user selects the defect tracking identifier, a query can be automatically generated to request from a defect tracking system the defect information associated with the defect tracking identifier. As noted, the user can select the defect tracking identifier by selecting alphanumeric text representing the defect tracking identifier, selecting an icon or button associated with the defect tracking identifier, or selecting the defect tracking identifier in any other suitable manner.

At step 406, the defect information can be received from the defect tracking system. At step 408, the defect information can be presented in the source code editor. For example, the defect information can be presented on a display or in a print of the source code. As noted, in one embodiment the defect information can be presented in-line with the source code. For example, the defect information can be presented in a collapsible portion of the source code. In another embodiment, the defect information can be presented within the source code editor in another suitable manner.

At step 410, when a user again selects the defect tracking identifier, presentation of the defect information can be discontinued. For example, the collapsible portion of the source code can be collapsed so as to remove the defect information from view on the display.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Like numbers have been used to refer to the same items throughout this specification. The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. Within a system comprising a processor and a memory, a method of selectively presenting source code defect information within a source code editor, the method comprising:
presenting in the source code editor a defect tracking identifier that is associated with a defect record contained in a defect tracking system;
when a user selects the defect tracking identifier, automatically retrieving defect information associated with the defect from the defect tracking system; and
presenting the defect information in the source code editor.

2. The method of claim 1, wherein presenting in the source code editor the defect tracking identifier comprises:
presenting the defect tracking identifier as selectable alphanumeric characters in the source code presented by the source code editor.

3. The method of claim 1, further comprising:
presenting an icon or button proximate to the defect tracking identifier;
wherein the icon or button is associated with the defect tracking identifier and is configured to be selected by the user in order to select the defect tracking identifier.

4. The method of claim 1, wherein presenting in the source code editor the defect information comprises:
presenting the defect information in-line with source code.

5. The method of claim 4, wherein presenting the defect information in-line with source code comprises:
presenting the defect information in a collapsible section of the source code.

6. The method of claim 1, wherein automatically retrieving the defect information associated with the defect from the defect tracking system comprises:
automatically generating a query requesting from the defect tracking system the defect information associated with the defect tracking identifier.

7. The method of claim 1, further comprising:
when the user again selects the defect tracking identifier, discontinuing presentation of the defect information.

8. The method of claim 1, further comprising:
receiving a user input to place the defect tracking identifier into the source code.

9. Within a system comprising a processor and a memory, a method of selectively presenting source code defect information within a source code editor, the method comprising:
presenting in the source code editor a defect tracking identifier that is associated with a defect record contained in a defect tracking system;
presenting an icon or button proximate to the defect tracking identifier, wherein the icon or button is associated with the defect tracking identifier and is configured to be selected by a user in order to select the defect tracking identifier;
when the user selects the defect tracking identifier, automatically retrieving defect information associated with the defect from the defect tracking system; and
presenting the defect information in the source code editor.

10. The method of claim 9, wherein presenting in the source code editor the defect information comprises:
presenting the defect information in-line with source code.

11. The method of claim 10, wherein presenting the presenting the defect information in-line with source code comprises:
presenting the defect information in a collapsible section of source code.

12. The method of claim 9, wherein automatically retrieving defect information associated with the defect from the defect tracking system comprises:
automatically generating a query requesting from the defect tracking system the defect information associated with the defect tracking identifier.

13. The method of claim 9, further comprising:
when the user again selects the defect tracking identifier, discontinuing presentation of the defect information.

14. A computer program product comprising:
a computer readable storage medium having stored thereon computer readable program code that, when executed by a system comprising a processor and a memory, presents source code defect information within a source code editor, the computer readable storage medium comprising:
computer readable program code that presents in the source code editor a defect tracking identifier that is associated with a defect record contained in a defect tracking system;
computer readable program code that, when a user selects the defect tracking identifier, automatically retrieves defect information associated with the defect from the defect tracking system; and
computer readable program code that presents the defect information in the source code editor.

15. The computer program product of claim 14, wherein the computer readable program code that presents in the source code editor the defect tracking identifier comprises:
computer readable program code that presents the defect tracking identifier as selectable alphanumeric characters in the source code presented by the source code editor.

16. The computer program product of claim 14, the computer readable storage medium further comprising:
computer readable program code that presents an icon or button proximate to the defect tracking identifier;
wherein the icon or button is associated with the defect tracking identifier and is configured to be selected to select the defect tracking identifier.

17. The computer program product of claim 14, wherein the computer readable program code that presents the defect information in the source code editor comprises:
computer readable program code that presents the defect information in-line with source code.

18. The computer program product of claim 17, wherein the computer readable program code that presents the defect information in-line with source code comprises:
computer readable program code that presents the defect information in a collapsible section of the source code.

19. The computer program product of claim 14, wherein the computer readable program code that automatically retrieves the defect information associated with the defect from the defect tracking system comprises:
computer readable program code that automatically generates a query requesting from the defect tracking system the defect information associated with the defect tracking identifier.

20. The computer program product of claim 14, the computer readable storage medium further comprising:
computer readable program code that, when the user again selects the defect tracking identifier, discontinues presentation of the defect information.
